(19) United States
(12) Patent Application Publication
(10) Pub. No.: US 2017/0273336 A1
(43) Pub. Date: Sep. 28, 2017

(54) DAIRY-BASED DOG CHEW

(71) Applicants: Brett Weinberg, San Clemnete, CA (US); Lucas Saxe, Laguna Beach, CA (US); Michael Farmer, Southlake, TX (US)

(72) Inventors: Brett Weinberg, San Clemnete, CA (US); Lucas Saxe, Laguna Beach, CA (US); Michael Farmer, Southlake, TX (US)

(21) Appl. No.: 15/072,755

(22) Filed: Mar. 17, 2016

Related U.S. Application Data
(60) Provisional application No. 62/134,507, filed on Mar. 17, 2015.

(51) Int. Cl. A23K 50/40; A23K 20/10; A23K 10/00; A23K 40/20; A23K 40/25

(52) U.S. Cl. CPC A23K 50/40; A23K 40/20; A23K 40/25; A23K 10/00; A23K 20/10

(57) ABSTRACT

A dog chew formed from a dairy-based material, wherein said dairy-based material is a mixture of one or more dairy ingredients combined with a binding agent, and said mixture of one or more dairy ingredients comprises the largest portion, by weight, of the dog chew, and said binding agent is added in a sufficient quantity to allow the dairy-based material to be pliable and stable. In the preferred embodiment, the dog chew also includes a flavoring material wherein the dairy-based material comprises the majority of the exterior surface of the dog chew, and said flavoring material includes meats from poultry, mammals, or fish.

### FIELD OF THE INVENTION

The present invention relates to dog chews, in particular a versatile dairy-based dog chew material that can be used in a variety of dog chews and provides nutritional and other positive benefits, while also providing a positive chewing activity for a pet which can help deter poor behavior such as chewing on furniture.

### BACKGROUND OF THE INVENTION

A review of the dog chew category reveals a large assortment of known chew products for dogs, including dog chews made of a variety of materials and comprising various shapes, sizes and styles. This large assortment centers on the idea that dog chews are an effective method to clean dogs' teeth resulting in better oral hygiene and improved breath for the pet. In addition these items provide a positive time occupier for the pet which prevents them from chewing on other objects like home furnishings and clothing. In certain iterations additives are applied to provide nutritional benefits for the pet. Health and beauty additives can also be applied for enhancing the product and, in turn, its claimed benefits. For example, Vitamin E can be added for improved skin and coat benefits.

Dog Chew products typically include chews made from animal skins (such as rawhide), synthetic chew toys made from a variety of materials such as plastic or nylon, and products made from vegetable based formulations like starches and wheat. While a large assortment of products exist in the market place today, they all have inherent flaws that can be improved upon, some of which are addresses by the current invention.

The U.S. dog chew category is currently valued at approximately $913 million dollars at retail sales across all channels of trade. Despite the size and importance of the category it has not shown significant growth despite the growth in pet ownership over the past 10 years. This lack of growth can be attributed to the inherent product limitations and consumer concerns within the categories on all current forms of pet chews. Products currently on the market have consumers well aware of the category flaws. National attention has been given to the product recalls on chew products for various safety concerns, such as chocking and bowel obstruction, as well as salmonella contamination in meat-based chews. Such attention has elevated pet owner concerns surrounding digestibility and manufacturing of chews on the market. Safety concerns coupled with the lack of nutritional benefits in common chews emphasizes the clear need for innovation within the category.

Ingredients—Each of the existing chew types have inherent flaws with the base material they are made from, namely rawhide, vegetable/plant material, and/or synthetic material such as nylon. Rawhide is digested slowly, if at all. As such, large pieces have been known to cause intestinal blockage. Vegetable-based chews contain ingredients that are known allergens for dogs that pet owners look to avoid. Synthetic chews are 100% indigestible for the dog and present a serious threat for chocking or intestinal blockage. A chew made from primarily dairy-based ingredients avoids these shortcomings.

Nutrition—Essential nutrients are those required by the pet that either cannot be synthesized by the body or cannot be synthesized in adequate amounts for good health. The biological value of a protein is a measure of that protein's ability to supply amino acids, particularly the 10 essential amino acids, and to supply these amino acids in the proper proportions. In general, animal proteins (meat, dairy, poultry and fish) have higher biological values than vegetable proteins (such as soybean meal or corn gluten meal). Therefore a chew made from a digestible animal protein (such as dairy) would be more biologically valuable for the pet than vegetable based chews. Rawhide chews provide little to no nutritional value for the pet so they are often sprayed with vitamin additives to provide some nutritional value. Dairy-based chews will provide useable amino acids in addition to nutrients such as calcium and vitamins like B, D, E and K, all important to a dog's overall health and well being.

Taste—Rawhide is inherently flavorless and vegetable based ingredients are less palatable to dogs than animal based ingredients. Thus, rawhide and vegetable based chews are often produced with flavor additives, and/or left unfinished by the dog. Dairy products have an inherent flavor that is enjoyable to dogs which will entice the pet to first taste the product and then consume it in its entirety. In addition, the combination of meat and dairy is one that provides superior palatability for the dog. By making a chew material from an easily pliable and moldable dairy-based blend, meats and other beneficial ingredients can easily be incorporated into the chew and can enhance the palatability and nutritional profile of the chew.

Digestibility—Rawhide is inherently difficult to digest, many of the plant based chews on the market, though digestible, have been recalled due to bowel obstruction caused by the expansion of the plant based materials in a dog's gut, and synthetic chews are 100% indigestible. By creating a chew that is made primarily from dairy based materials you create a product that is almost wholly digestible while removing the liability of ingredient expansion once consumed.

The below is a discussion of the four categories of dog-chews, relating to the present invention, existing in the market place today:

### 5. Animal Skin Based Chews (Rawhide and/or Porkhide)

Rawhide is currently the most common chew for dogs. However, despite significant growth in dog ownership and subsequent growth in the dog treat and chew categories, (20%+ since 2003), rawhide retail purchases have remained relatively flat since 2003. One reason this segment of chews has remained stagnant is many people are concerned with the methodology and lack of regulations on the production of rawhide. Because rawhide is a by-product of the leather and tannery industry, the extent of chemicals, antibiotics and other potentially harmful additives within the products are unknown. Nor are they required by law to be disclosed. Hides are split (separated) during manufacturing bringing into question what chemicals and/or processes are employed. Because nutritional claims are not made on the final product, consumer labeling disclosure is not legally required.

In addition to manufacturing concerns of rawhide pet chews, consumers question the digestibility of the product. There are several products on the market today that spray enzymes on rawhide to try and combat this issue. Consumers uncertainty aside, rawhide digests extremely slow, if at all. Pieces of rawhide, which naturally breakdown very slowly within a pet's gastro intestinal tract, can cause severe medical issues if a blockage occurs.

Further, rawhide is flavorless and provides almost no nutritional value for the pet. As such, many types of rawhide are often infused with flavoring, secondary ingredients (like meat), and vitamin/mineral additives like vitamin E. To add flavor to help insure the products are consumed in their entirety many manufacturers need to apply topical flavorings or add meat to the center of the chew in order to get the pet to chew the product. One such example of this is the dog chews disclosed by U.S. Pat. No. 5,673,653, showing a meat (jerky) layer secured within a traditional rawhide chew. This adds costs to the product and also can be ineffective due to uneven application of the nutrients and evaporation during the drying process, and in no way mitigates the problems with rawhide mentioned above, such as digestibility.

### 6. Plant-Based (Vegetable/Soy/Grain/Starch) Chews

Vegetable based chews, that is chews that use vegetable and/or plant materials as a substantial ingredient, such as the dog chew disclosed by U.S. Pat. No. 6,093,427 and U.S. Pat. No. 7,677,203, are the second most commonly purchased form of chew for dogs. These products are often made from a base material such as wheat, wheat glutens, corn, soy protein isolate, pea protein, potato, tapioca and/or corn starch. There are several issues with these forms of chews.

One such issue is intestinal blockage. The inherent nature of starch-based materials has the potential for expansion once in a pet's stomach. In addition, these formulations are also slowly digested further compounding the issue.

In addition to blockage, allergies can be a problem when using vegetable based chews. Wheat, corn and soy (the most common ingredients used to create vegetable based chews) are among the most common food based allergies for dogs. This fact has become so prevalent with consumers that nearly half of all pet foods sold in the U.S. are now formulated to be free of corn, wheat and soy.

While these vegetables contain a large amount of protein, these proteins provide almost none of the essential amino acids for a dog (essential amino acids are those that a dog cannot synthesize and must be received through diet) further limiting the benefit of these chews.

Much like rawhide, there are palatability issues with the base ingredients contained in vegetable chews for dogs. As such palatability enhancers and/or secondary proteins sources are often added to the products to entice consumption. One such example of this is the dog chews disclosed by U.S. Pat. No. 7,677,203, disclosing a protein (preferably jerky) layer secured within a plant-based casing.

U.S. Pat. No. 6,093,427 discloses a chew made from filamentaneous vegetable matter such as dried spinach, asparagus, broccoli, beans or peas. Though these chews avoid some of the digestibility problems associated with the starch and carbohydrates based ingredients above, these ingredients suffer from the same nutritional and palatability concerns.

### 7. Synthetic Chews

Many dog chews are made from synthetic materials such as plastic, nylon or rubber. These products often provide a long lasting chew for dogs, but they are completely indigestible. This represents a significant health risk for dogs when they break a portion of the chew off and swallow it. Again, palatability concerns arise as synthetic based chews have no natural flavors of interest to a dog.

Additionally, these synthetic chews are made from plastics and nylons and provide zero nutritional value for the pet.

### 8. Unshaped Cheese

Currently there are also cheese products on the market, such as the Barkworthies Big Cheese Chew and the Himalayan Dog Chew, both of which are unmolded blocks of hard cheese, containing only Yak's and Cow's Milk along with salt and lime juice. These products are simply cheese with no other ingredients and no molding or shaping, comparable to simply buying a piece of dehydrated human cheese and giving it to a dog.

Though the products have some nutritional and flavor benefits, they also have several shortcomings. Because the block is simply dehydrated hard cheese, it is not pliable at has limited digestibility for dogs, which reduces the possible nutritional benefits and creates potential intestinal blockage issues for the pet. Further, the cheese materials hardness cannot be changed through molding and the hardness can be problematic for a dog's teeth, potentially leading to breakage and unnecessary wear. Further, a block of hard cheese is not easily shaped and molded into desirable shapes for dog treats, which limits the shapes available, and importantly limits the versatility of the chew and the ability to incorporate other ingredients as part of the chew. Finally, such treats lack palatability for many dogs, because of the hardness of product (texture is important in creating palatability in products for dogs), and is further limited by the inability to add anything inside the product to enhance palatability.

The present invention discloses a pliable, readily moldable, dairy-based chew material that provides the traditional benefits of a dog chew, while also providing nutritional, palatability and digestibility benefits, in a safe low cost product. The material is also malleable and can be molded and shaped into a variety of styles, and easily allows for the incorporation of additional ingredients.

### SUMMARY OF THE INVENTION

The present invention relates to an edible pet chew that has at least an outer material made primarily of a dairy base. The dairy base can be a single dairy ingredient, or a mixture of dairy ingredients (such as whey, casein, cheese, milk, etc. . . . ), and the dairy base comprises a larger percentage, by weight, than any other combination of ingredients within a particular food group (starch, grain, meat, etc. . . . ) found in the pet chew material.

A dairy-based chew is made by combining dairy-based ingredient(s) (milk, cheese, yogurt, casein, whey, etc. . . . ) with various other ingredients to create a hardened or semi-hardened form, wherein the dairy-based ingredients comprise the largest portion of the formula. The blended mixture will allow for various shapes and textures to be formed out of the materials through a variety of methods of manufacturing. After the mixture is formed into the desired shape, it is dehydrated (fully or partially) and/or cooled. By removing moisture, applying pressure and/or cooling the material it will become hard enough to form a chew for dogs. The exact hardness of the product can then be controlled by the amount of pressure/cooling or drying applied to the material allowing for variation in the hardness of the final product, and chew products that can be designed for use by a particular segment of dogs (such as small, medium, large, heavy chewers, light chewers etc. . . . )

The dairy-based chew will improve palatability and digestibility without the need of flavor additives, because of the inherent nutritional value and palatability of the dairy-based raw materials. Further, dogs would receive the benefits of calcium, amino acids and other positive nutritional elements contained within the chew without the need for additional additives to be applied to the chew.

In addition to creating a better chew on its own, this dairy-based chew material will allow for meat or other nutritional and palatability agents to be easily incorporated into the chew treat.

In one embodiment the dairy-based chew would be made into thin sheets or strips using various manufacturing techniques. This sheeted material can then be made into a variety of shapes, and can easily be layered and combined with a variety of additional ingredients such as jerky and other beneficial ingredients.

In other embodiments the dairy-based chew chews would be injected molded into various shapes.

In other embodiments these chews would be formed using compression molding.

Whether using thin sheets, extrusion, compression molding, or injecting molding, in all iterations beneficial ingredients such as meats from poultry, mammals, fish, etc. can be added to the center of these chews to create a treat/chew combo item.

### BRIEF DESCRIPTION OF THE DRAWINGS

FIG. 1 illustrates a perspective view of the preferred embodiment for a molded or extruded dog chew of the present invention;

FIG. 2 illustrates a perspective view of layered sheets which can be formed into an alternate embodiment for a dog chew of the present invention;

FIG. 3 illustrates a perspective view of an alternate embodiment for a rolled dog chew of the present invention;

FIG. 4 illustrates a perspective view of an alternate embodiment for a tied dog chew of the present invention;

FIG. 5 illustrates a perspective view of an alternate embodiment for a twisted dog chew of the present invention;

FIG. 6 illustrates a perspective view of an alternate embodiment for a molded or extruded dog chew of the present invention.

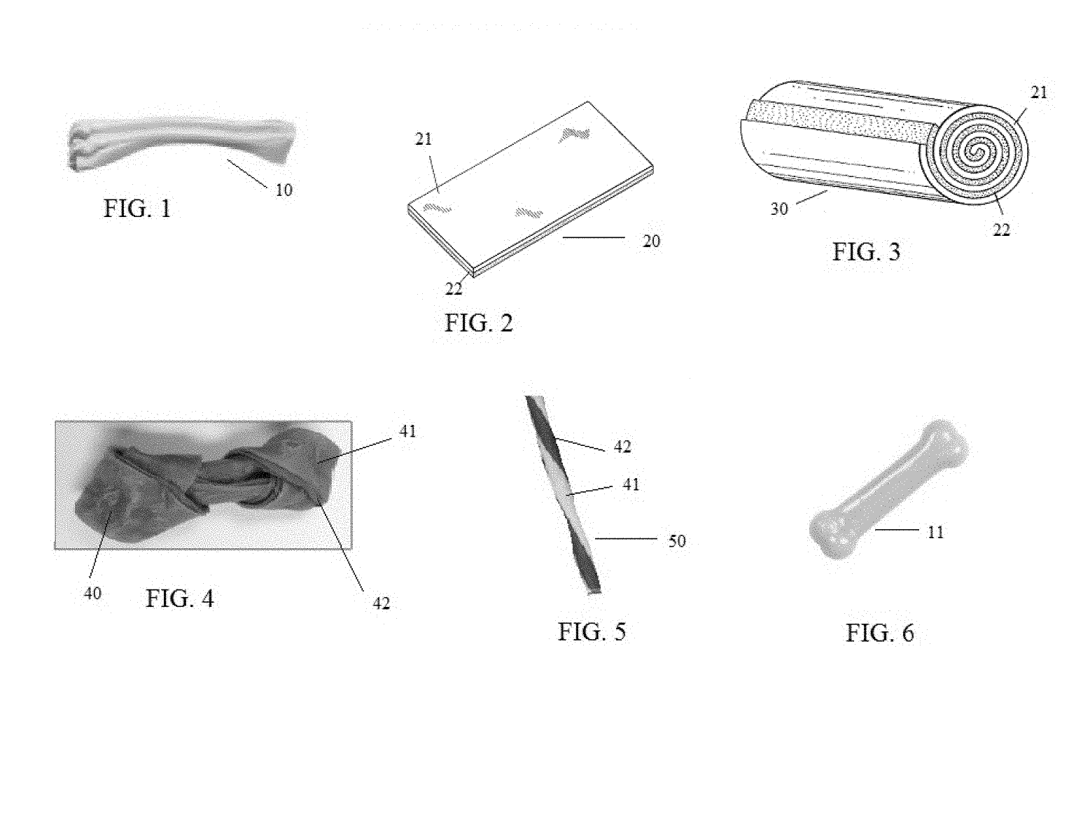

### DETAILED DESCRIPTION OF AN EMBODIMENT

In the preferred embodiment a dairy-based chew material (10, 11, 21, 41) is created by combining at least one dairy ingredient with binding agents and preservatives. These binding agents can be starches like potato, of animal origin like gelatin, or plant based like wheat gluten. In addition preservatives or water stabilizers, like vegetable glycerin, may be added to the formulation for shelf stability. The binding agents added to the dairy are only added to a level that allows the material to reach a pliable texture that can be molded, extruded, or formed. The percentage, by weight, of binding agents in the formula shall not exceed the percentage of the combined dairy ingredient(s) in the formula. Other binding agents and preservatives may be used in addition to those listed above. The below three example ingredient lists show the components of three possible embodiments for the dairy-based chew material of the current invention, and provided are for illustrative purposes, and are not intended to limit the present invention to the ingredients listed.
Example 1: Cheese (Skim Milk, Enzyme's, Salt), Potato Starch, Glycerin, Sorbitol.
Example 2: Whey, Casein (Milk Protein), Glycerin, Gelatin, Cheddar Cheese Powder, Natural Liver Flavor, Smoke Flavor, Cheese Flavor, Sodium Propionate.
Example 3: Casein (Milk Protein), Potato Starch, Glycerin, Gelatin, Cheddar Cheese Powder, Water Sufficient for Manufacturing, Natural Chicken Liver Flavor, Palm Oil, Smoke Flavor, Titanium Dioxide, Sodium, FD&C Yellow #5

In one embodiment the dairy-based chew material is formed into thin sheets (21). These thin sheets (21) can be manufactured through extrusion, compression, rolling or dehydrating the material on large trays until it reaches a semi-pliable or non-pliable state. These sheets can then be rolled into the shape of a cylinder (30) or cut into shapes or strips (41). The sheets may be cut into thin strips (41) which can be cut and then tied, twisted or rolled into a variety of shapes, such as a bone (40) or twist (50).

In another embodiment the dairy-based chew material can be formed using injection or compression molding. The dairy-based chew material can easily be molded into desirable shapes, such as a molded bone (11).

For injection molding, the dairy-based chew material is heated and then forced through a nozzle into a formed cavity where it cools and hardens to the configuration of the cavity. When the mixture has sufficiently hardened, the mold opens and the fully formed chew is removed. For compression molding, the dairy-based chew material is pre-heated and then placed onto an open heated mold cavity. The mold is then closed and pressure is applied to force the material into contact with all mold areas. The heat and pressure is maintained until the dairy-based material has been cured. Once this material is cured it is removed from the mold. Additional drying and cooling may or may not be necessary following the molding of the shape to make the material hard enough to be sufficient to withstand dog's chewing, depending on the target dog category for the specific chew being manufactured.

In certain embodiments the dairy-based material can be made through extrusion. In this iteration the dairy-based material is heated and forced through a die. The product shape can then be changed by using a different die on the extruder head. Once the material is forced through the die it is then cut to the appropriate length and dried.

In each of the above embodiments, a second layer of a flavored material may be added to the dairy-based material. This second layer can be a piece of dried or dehydrated poultry, meat or fish or a combination of ingredients like meats and other binding agents to make the material pliable enough so that it can be formed. This secondary material is then formed or cut into a second sheet. The dairy-based material and the flavored material are then formed together into chews and then hardened through baking, dehydration or other manufacturing techniques to create a chew/treat combination.

In one embodiment, as shown in FIGS. 2 and 3, a sheet of meat or jerky (22) is placed on top of the sheet of dairy-based chew material (21), and the sheets are rolled together into a cylindrical dog chew (30). The dairy-based chew material sheet (22) creates an exterior material, with the sheet of meat or jerky (22) on the inside, further encouraging the dog to chew to access to meat rolled within the chew.

In another embodiment the sheet of dairy-based chew material (21) and sheet of meat or jerky (22) can be cut into strips (41 and 42 respectively). Alternatively, the dairy-based material and secondary meat or jerky material can be extruded into similar thin strips. When extruding, the mixtures are heated to a temperature so that the material does not burn, yet is fluid enough that it can be forced through an extruder into strips.

These strips can then be tied into the shapes like a dog bone, rolls, cylinder or twist. The strips can then be shaped into a variety of treats, such as being formed into twists (50) or tied into a bone-shape (40).

A second layer of a flavored material may be added to the molded dairy chew materials as well. When using injection or compression molding, a secondary cavity is added to the mold for the injected/compressed dairy chew material. At the same time the dairy-based material is injected (or poured) into the mold, a secondary flavored material (as outlined above) is also injected (or poured) into the cavity contained within the primary mold (the cavity serves as a second mold). The combined chew is cooled and hardened together to create a single chew for dogs, with the dairy material on the exterior, and the flavored material at least partially encapsulated within the molded chew.

Alternatively, the flavored material can be added as a separate process. In these embodiments, a hole can be created in the center of the injection or compression molded dairy-based chew. After molding, this hole can then be filled with a secondary flavored material via a secondary application.

What is claimed is:

1. A dog chew formed from a dairy-based material, wherein said dairy-based material comprises a mixture of one or more dairy ingredients combined with a binding agent, and said mixture of one or more dairy ingredients comprises the largest portion, by weight, of the dog chew, and said binding agent is added in a sufficient quantity to allow the dairy-based material to be pliable and stable.

2. The dog chew of claim 1, wherein said dairy-based material comprises a thin sheet rolled into a cylinder.

3. The dog chew of claim 1, wherein said dairy-based material comprises one or more thin strips made through sheeting or extrusion, and said thin strips are tied or twisted into a final shape.

4. The dog chew of claim 1, wherein said dairy-based material comprises a molded shape.

5. The dog chew of claim 1, wherein said dairy-based material comprises an extruded shape.

6. The dog chew of claim 1, further comprising a flavoring material wherein the dairy-based material comprises the majority of the exterior surface of the dog chew, and said flavoring material includes meats from poultry, mammals, or fish.

7. The dog chew of claim 6, wherein the dairy-based material comprises a thin sheet and the flavoring material comprises a separate thin sheet, and said thin sheet of dairy-based material and said thin sheet of flavoring material are super imposed and rolled together into a cylinder.

8. The dog chew of claim 6, wherein the dairy-based material comprises one or more thin strips and the flavoring material comprises one or more separate thin strips, and said thin strips of dairy-based material and said thin strips of flavoring material are rolled, twisted or tied together into the final shape.

9. The dog chew of claim 6, wherein said dairy-based material comprises a molded shape, and said molded shape further comprises a cavity, wherein said cavity is filled with the flavoring material.

10. The dog chew of claim 6, wherein the dairy-based material comprises an extruded shape, and the flavoring material comprises a separate extruded shape

11. A method for manufacturing a dog chew comprising:
Heating a mixture of one or more dairy ingredients and at least one binding agent at a temperature sufficient to form a liquid mixture, wherein said one or more dairy ingredients comprises the largest portion, by weight, of the mixture; pouring the liquid mixture into thin sheets; allowing the thin sheets to cool and dry into a semi-pliable state such that each thin sheet of dairy-based material can be shaped into a final product.

12. The method for manufacturing a dog chew of claim 11, further comprising:
providing a flavoring material, wherein said flavoring material includes meats from poultry, mammals, or fish; forming said flavoring material into a thin sheet; layering the thin sheet of flavoring material on top of a thin sheet of dairy-based material; and rolling said layered sheets into a cylinder such that the thin sheet of dairy-based material comprises the majority of the exterior of the dog chew, and the majority of the thin sheet of flavoring material is enclosed within the dog chew.

13. A method for manufacturing a dog chew comprising:
Heating a mixture of one or more dairy ingredients and at least one binding agent at a temperature sufficient to form a liquid mixture, wherein said one or more dairy ingredients comprises the largest portion, by weight, of the mixture; pouring the liquid mixture into thin sheets; allowing the thin sheets to dry into a semi-pliable state; cutting the sheets into strips of dairy-based material; cutting said strips into various lengths; and forming a plurality of said strips into a final products by twisting or tying the strips together.

14. The method for manufacturing a dog chew of claim 13, further comprising:
providing a flavoring material, wherein said flavoring material includes meats from poultry, mammals, or fish; forming said flavoring material into a thin sheet; cutting the sheet into strips of flavoring material; cutting said strips of flavoring material into various lengths; twisting or tying one or more strips of dairy-based material together with one or more strips of flavoring material to form the final product.

15. A method for manufacturing a dog chew comprising:
Heating a mixture of one more dairy ingredients and at least one binding agent at a temperature sufficient to form a liquid mixture, wherein said one or more dairy ingredients comprises the largest portion, by weight, of the mixture; forcing said mixture through an injection nozzle and into the cavity of a mold; allowing the mixture to cool and harden within the mold; opening the mold and removing the final formed product from the mold.

16. The method for manufacturing a dog chew of claim 15, further comprising:
creating at least one secondary cavity within the cavity of the mold; at the same time the liquid dairy based mixture is forced through the nozzle into the mold, a flavoring material is forced, through a separate injection nozzle, into the secondary cavity, such that a majority of said flavoring material is encapsulated within said liquid dairy mixture; allowing the mixture to cool and harden within the mold; opening the mold and removing the final formed product from the mold.

17. The method for manufacturing a dog chew of claim 15, further comprising:
creating at least one secondary cavity within the cavity of the mold such that when the liquid dairy mixture is forced into the mold, none of the mixture enters the secondary cavity; allowing the mixture to cool and harden within the mold; opening the mold and removing the formed product from the mold, said formed product containing a hole or opening where the secondary cavity was located; filling said hole or opening with a flavoring material.

18. A method for manufacturing a dog chew comprising:
Heating a mixture of one more dairy ingredients and at least one binding agent at a temperature sufficient to form a liquid mixture, wherein said one or more dairy ingredients comprises the largest portion, by weight, of the mixture; pouring said mixture into the cavity of a mold; closing the mold and applying force such that the liquid mixture is forced into contact with all areas of the mold; allowing the mixture to cure within the mold under heat and pressure; opening the mold and removing the final formed product form the mold; allowing the final formed product to dry until the desired pliability is reached.

19. The method for manufacturing a dog chew of claim 18, further comprising:
creating at least one secondary cavity within the cavity of the mold; at the same time the liquid dairy based mixture is poured into the mold, a flavoring material is poured into the secondary cavity, such that a majority of said flavoring material is at least partially encapsulated within said liquid dairy mixture; allowing the mixture to cure within the mold under heat and pressure; opening the mold and removing the final formed product form the mold; allowing the final formed product to dry until the desired pliability is reached.

20. The method for manufacturing a dog chew of claim 18, further comprising:
creating at least one secondary cavity within the cavity of the mold such that when the liquid dairy mixture is poured into the mold, none of the mixture enters the secondary cavity; allowing the mixture to cure and harden within the mold; opening the mold and removing the formed product from the mold, said formed product containing a hole or opening where the secondary cavity was located; filling said hole or opening with a flavoring material; and allowing the final formed product to dry until the desired pliability is reached.

21. A method for manufacturing a dog chew comprising:
Heating a mixture of one more dairy ingredients and at least one binding agent at a temperature sufficient to form a liquid mixture, wherein said one or more dairy ingredients comprises the largest portion, by weight, of the mixture; forcing said liquid mixture through an extruder head using a spindle in order to form extruded strips of dairy-based material; cutting said strips into various lengths; tying or twisting said strips into a desired shape; and placing said shapes on to baking trays where they are dried to a moisture content of no more than 25%.

22. The method for manufacturing a dog chew of claim 21, further comprising:
a thin strip of a meat based material; twisting or tying one or more strips of dairy-based material together with one or more strips of meat based material to form the final product, such that when the final shape is formed the meat-based material is encapsulated within the dairy-based material while still having some of the meat-based material visible on the exterior of the dog chew.
